(19) United States
(12) Patent Application Publication
(10) Pub. No.: US 2013/0022021 A1
(43) Pub. Date: Jan. 24, 2013

(54) FEEDBACK FOR MULTI-USER MIMO SYSTEMS

(71) Applicants: Thorsten Wild, Stuttgart (DE); Elmar Schmidberger, Stuttgart (DE)

(72) Inventors: Thorsten Wild, Stuttgart (DE); Elmar Schmidberger, Stuttgart (DE)

(73) Assignee: ALCATEL LUCENT, Paris (FR)

(21) Appl. No.: 13/637,736

(22) PCT Filed: Mar. 7, 2011
(86) PCT No.: PCT/EP11/53350

§ 371 Date: Sep. 27, 2012

(30) Foreign Application Priority Data
Apr. 1, 2010 (EP) 10290176.6

(51) Int. Cl. H04W 72/04

(52) U.S. Cl. 370/330

(57) ABSTRACT

A base station (BS) for a SDMA-capable cell (C) of a radio communications system (1), adapted for: receiving precoding vector information (PMI) indicating a primary precoding vector (w_{PMI}) in an ordered set of precoding vectors (w), receiving channel quality information (CQI) indicating a channel quality when using the primary precoding vector (wPMₗ) for scheduling a first user equipment (UE1), receiving channel quality degradation information (delta-CQI1 to delta-CQI4) indicating a degradation of a channel quality when scheduling a second user equipment (UE2) on the same time and frequency resources using a secondary precoding vector (w_{FCI}) from a pre-defined ordered set of secondary precoding vectors selected in dependence of the primary precoding vector (w_{PMI}), the base station (BS) being further adapted for: correlating the channel quality degradation information (delta-CQI1 to delta-CQI4) with corresponding secondary precoding vectors (w_{FCI}) of the selected ordered set based on an order of reception of the channel quality degradation information (delta-CQI1 to delta-CQI4). The invention also relates to a user equipment (UE1, UE2), to a cell (C), to a radio communications system (1), and to a corresponding method.

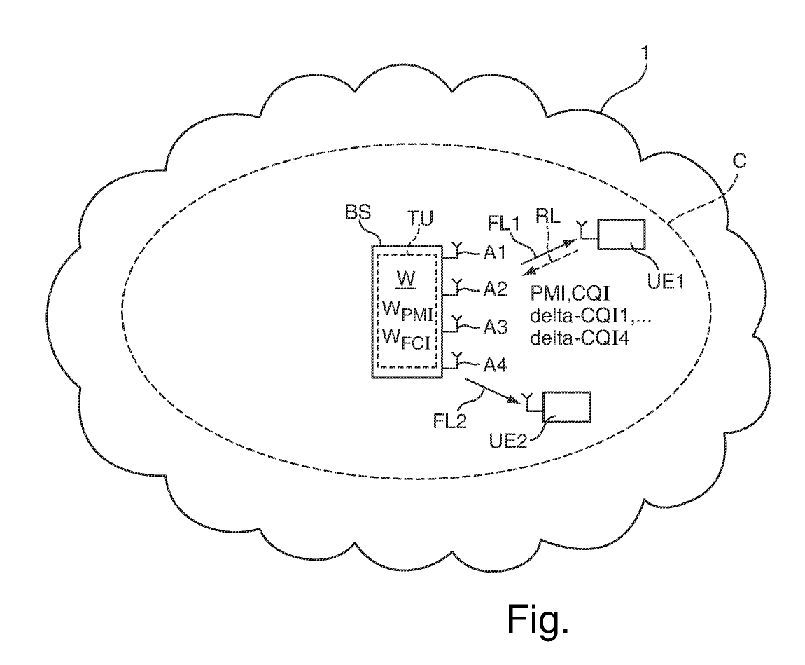

### FIELD OF THE INVENTION

The invention relates to the field of telecommunications, and, more specifically, to radio communications networks comprising at least one Space-Division Multiplex, SDMA, capable cell.

### BACKGROUND

This section introduces aspects that may be helpful in facilitating a better understanding of the invention. Accordingly, the statements of this section are to be read in this light and are not to be understood as admissions about what is in the prior art or what is not in the prior art.

In radio communications networks supporting Multiple-Input-Multiple-Output (MIMO) with downlink precoding, e.g. systems of the Long-Term Evolution, LTE, type, a pre-defined ordered set of precoding vectors (codebook) is known both at the base station and at the user equipments served by the base station. For finding an optimum precoding vector (or precoding matrix) for downlink transmissions to a specific user equipment, a preferred precoding vector is determined, the preferred precoding vector typically optimizing a certain optimality metric such as a transmission throughput according to a specific scheduling criterion. A preferred precoding vector index, PMI, indexing one of the ordered set of precoding vectors of the codebook is then fed back to the base station, together with a channel quality indicator indicating a channel quality when using the primary precoding vector for scheduling the user equipment on a specific time and frequency resource (block). The channel quality information may then be used for selecting an appropriate transport format (modulation and coding scheme) for downlink transmissions to the user equipments using the preferred precoding vector.

However, in this way, MIMO with downlink precoding is provided only to a single user, but no solution for multi-user MIMO is provided, i.e. for the case that two or more users are to be scheduled simultaneously on the same resources. For multi-user MIMO, a selection of combinations of user equipments which are best suited for multi-user transmissions has to be performed. In this respect, the inventors have proposed to provide an additional index of a preferred multi-user-MIMO pairing partner as additional feedback information to the base station. This so-called best companion index (BCI) may be accompanied by a corresponding channel quality degradation information (delta-CQI), indicating a change/degradation of a channel quality (and thus of a desired transport format) when a co-scheduled pairing partner is served on the same multiple access resource. Optionally, multiple Bas+delta-CQIs may be reported (resulting in a higher feedback overhead).

A problem when only a single BCI (+delta-CQI) is provided as feedback information is that the probability of finding suitable pairing combinations is low when the ratio of the number of active users over the codebook size gets small (e.g. <1). This could be improved by offering multiple best companions and corresponding delta-CQIs via feedback, but this multiplies the required feedback signaling overhead.

For instance, LTE Release8 with 4 antennas at the base station uses a 4 bit PMI and a 5 bit CQI. Each best companion may require e.g. a 4 bit BCI and a 3 bit delta-CQI. So with 1, 2, 3, . . . reported best companions, the signaling feedback overhead increases by 77%, 155%, 233%, . . . . However, such large feedback rates for the case of a low number of users is not desirable and may be even impossible to achieve in some situations.

### SUMMARY

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

A first aspect of the invention relates to a base station for a SDMA-capable cell of a radio communications system, adapted for: receiving precoding vector information indicating a primary precoding vector in an ordered set of precoding vectors; receiving channel quality information indicating a channel quality when using the primary precoding vector for scheduling a first user equipment; receiving channel quality degradation information indicating a degradation of a channel quality when scheduling a second user equipment on the same time and frequency resources using a secondary precoding vector of a pre-defined ordered set of secondary precoding vectors being selected in dependence of the primary precoding vector; the base station being further adapted for: correlating the channel quality degradation information with corresponding secondary precoding vectors of the selected ordered set based on an order of reception of the channel quality degradation information.

The basic idea for reducing the feedback overhead is to report the channel quality degradation information (delta-CQI) for an ordered fixed (pre-defined) set of (secondary) precoding vectors which varies in dependence of the first precoding vector (PMI). The secondary precoding vectors related to the different first precoding vectors may be stored in a table at both ends of the link (base station and user equipments). The order of the received channel quality degradation information allows an implicit assignment of the channel quality degradation information to the secondary precoding vectors of a given ordered set secondary precoding vectors. In this way, information about potential co-scheduled pairing partners may be provided without the need for transmitting an additional index indicating the co-scheduled partner. In other words, the feedback bits for the best companion index BCI may be dropped. They are not required anymore, as the order of the channel quality degradation information defines the corresponding fixed companion index, and the feedback overhead may be reduced considerably.

It will be understood that although the above description has been given for a single codebook index (PMI), an extension to multi-stage precoding feedback may be easily achieved. In multi-stage precoding, a common composite precoding codebook can be formed from multiple (e.g. two) codebooks, where a first PMI describes an index in the first codebook (e.g. indicating long-term changes), while a second PMI describes an index in a second codebook (e.g. for short-term changes) etc. The resulting composite precoding weights are obtained by a combination of the weights associated to those codebook indices (PMIs). The combination may e.g. performed by a matrix multiplication or a Kronecker product.

The ordered set of fixed companions (secondary precoding vectors) may now be combined with this multi-stage precoding feedback, e.g. in the following way: The secondary precoding vectors which are used for reporting the cannel quality degradation information (delta-CQIs) may be chosen as a subset of the overall composite codebook. Alternatively, the secondary precoding vectors may be chosen only from one part of the composite codebook, and an averaging of the delta-CQIs of another part of the codebook may be performed. For instance, it is possible to perform signalling of the delta-CQIs associated to the first codebook, while forming an average over all possible entries of the second codebook (or vice versa). Alternatively, the averaging may also be done over a subset, e.g. best N, where N is an integer which could range from one to the number of codebook entries.

In one embodiment, the base station further comprises: a transmission unit adapted for serving the first user equipment using the primary precoding vector, the transmission unit being further adapted for serving the second user equipment on the same time and frequency resources using one of the plurality of secondary precoding vectors. The secondary precoding vector which is used for transmissions to the second user equipment may be selected based on the value of the channel quality degradation information which typically varies for the different secondary precoding vectors, and on other scheduling constraints. In this respect, as described above, a channel quality degradation information averaged over all or some of the fixed companions/secondary precoding vectors of a given set may be reported in order to further reduce the required feedback rate.

In another embodiment, the base station is further adapted for signaling information about the ordered sets of secondary precoding vectors associated with respective primary precoding vectors to the user equipments of the cell. The secondary precoding vectors contained in a set associated with a respective primary precoding vector may be determined e.g. by simulations or measurements during a setup of the cell. The information about the ordered sets may then be transmitted to the user equipments arranged in the cell e.g. during a link setup. Alternatively, the attribution of secondary precoding vectors to a given primary precoding vector may be changed on the fly, i.e. when the link has already been established and traffic is exchanged on the link. The change of the attribution of secondary precoding vectors to primary precoding vectors may be induced e.g. by measurements indicating a change of a channel quality in the channels of the cell.

A second aspect relates to a user equipment for a SDMA capable cell of a radio communications system, the cell being adapted for: generating precoding vector information for indicating/indexing a primary precoding vector in an ordered set of precoding vectors, generating channel quality information indicating a channel quality when using the primary precoding vector for scheduling a first user equipment, and generating an ordered set of channel quality degradation information indicating a degradation of a channel quality when scheduling a second user equipment on the same time and frequency resources using a secondary precoding vector from a pre-defined ordered set of secondary precoding vectors being selected in dependence of the primary precoding vector.

The information about the order of secondary precoding vectors in a given set of secondary precoding vectors is typically made available to the user equipment by signaling from the base station. Thus, the user equipment may generate a sequence (ordered set) of channel quality degradation information which is transmitted as feedback to the base station, such that the base station may use the order of reception for correlating the bit sequences of the channel quality degradation information to a corresponding secondary precoding vector.

In one embodiment, the user equipment is further adapted for: determining the channel quality degradation information from a channel quality after receive combining, taking intra-cell interference due to transmissions using the secondary precoding vector into account. Once the primary precoding vector (PMI) has been selected, the channel quality degradation information is calculated for each of the secondary precoding vectors of the ordered set which is associated with the selected primary precoding vector, i.e. the channel quality degradation information is determined for the codebook entries of the potential pairing partners.

For quantification of the channel quality degradation, a (logarithmic) measure of the difference between the unpaired and the paired channel quality may be chosen. For both situations, the respective channel quality may be determined e.g. as a signal-to-interference-noise ratio, SINR, at the output of a receive combiner, e.g. based on a Minimum-Mean-Square-Error, MMSE calculation. In this specific case, the values of the channel quality degradation information are negative, as they indicate a loss due to pairing, caused by intra-cell interference and splitting of transmit power of the base station to the two user equipments.

In a further embodiment, an influence of a pre-defined power splitting to the user equipments on the channel quality degradation is removed from the channel quality degradation information provided as a feedback. In case that the power splitting is known, e.g. when an equal power splitting to both user equipments is performed, the channel quality degradation expressed as a SINR difference is at least 3 dB. Thus, one may subtract this contribution from the value of the channel quality degradation information which is reported to the base station in order to increase the dynamic range of the limited number of bits which are used for the feedback. The channel quality degradation due to the power splitting is known at the base station and will be taken into account for the scheduling process.

Further aspects of the invention relate to a SDMA-capable cell for a radio communications system, e.g. in compliance with the LTE or LTE advanced standard, comprising: at least one of a base station as described above and a user equipment as described above, as well as to a radio communications system comprising at least one such SDMA-capable cell.

As is well-known, a cell providing SDMA capability typically has a base station with a number of N (e.g. N=4) transmit antennas being arranged in an (active) antenna array. The different antennas of the array are addressed using precoding information (in the present case: precoding vectors), each precoding vector having a number of entries (antenna weights) corresponding to the number of transmit antennas. In the present case, it has been supposed that the transmission rank R is one, i.e. that the number of data layers multiplexed in the spatial domain is one. If a higher transmission rank R is used, the precoding vectors will be replaced by precoding matrices (N×R) containing a number R of precoding vectors. However, one skilled in the art will readily appreciate that using a higher transmission rank R=2, 3, . . . will not affect the approach as described herein, the only difference being that the precoding vectors will be replaced by precoding matrices. Also, as indicated above, the approach described herein may be easily extended to the case of a composite precoding codebook using two or more codebook indices (PMIS).

A further aspect of the invention relates to a method for providing information for scheduling at least two user equipments on the same resources of a SDMA-capable cell of a radio communications system, the method comprising: providing precoding vector information indicating a primary precoding vector in an ordered set of precoding vectors; providing channel quality information indicating a channel quality when using the primary precoding vector for scheduling a first user equipment, providing an ordered set of channel quality degradation information indicating a degradation of a channel quality when scheduling a second user equipment on the same time and frequency resources using a secondary precoding vector of a pre-defined ordered set of secondary precoding vectors, the pre-defined ordered set being selected in dependence of the primary precoding vector.

As has been described above, an (implicitly) ordered set of fixed companions (secondary precoding vectors) is associated with each codebook entry (primary precoding vector). As the specific order of the secondary precoding vectors is known at both ends of the link (user equipment(s) and base station), it is sufficient to feed back only the channel quality degradation information in an order with corresponds to that of the secondary precoding vectors. One skilled in the art will readily appreciate that it may also be possible to transmit the channel quality degradation information in an order which is a permutation of the order of the precoding vectors in the selected set, provided that the permutation (matrix) is known at both ends of the link, such that the base station may perform the assignment in a correct manner.

In one variant, an attribution of precoding vectors to the pre-defined ordered set of secondary precoding vectors is performed based on at least one of a relation of the precoding vectors to the primary precoding vector, in particular a distance metric to the primary precoding vector, and a channel quality statistics within the cell. Both the primary and the secondary precoding vectors belong to the same set of precoding vectors (codebook) defined for the cell. For each primary precoding vector of the codebook, a fixed number of secondary precoding vectors has to be chosen from the remainder of the precoding vectors of the codebook. A general design principle for the choice of the precoding vectors to be included into the set of fixed companions is to anticipate the attractive weight combinations for user pairing. This may be based e.g. on the following criteria: Angular properties of the precoding vectors (e.g. an angle of departure of a computed maximum of an antenna pattern) and a distance metric e.g. indicating orthogonality of the precoding/weight vectors. For example, quasi-orthogonality of the weight vectors may be determined by checking the scalar product (or another suitable distance metric) of the precoding vectors and choosing combinations of the primary precoding vector with secondary precoding vectors which result in a scalar product close to zero. Alternatively or in addition, the choice of secondary precoding vectors may be based on a SINR statistics obtained from simulations or measurements, e.g. on a channel quality statistics, tailored to antenna configuration, codebooks and propagation scenario.

In another variant, a pre-defined power splitting to the user equipments is performed, and a contribution of the pre-defined power splitting on the channel quality degradation is removed from the channel quality degradation information before transmission, thus increasing the dynamic range of the channel quality degradation information which is due to intra-cell interference, as the number of bits used for the feedback is limited.

In yet another variant, the method further comprises: determining the channel quality degradation information from a channel quality after receive combining, taking intra-cell interference due to transmissions using the secondary precoding vector into account. As indicated above, the channel quality degradation information may be expressed as a difference between the SINR of a single-user and a multi-user transmission. Now, either this difference may be reported directly or, e.g. in the case of LTE, the difference may be mapped to a change in a desired transport format index (using adaptive modulation and coding) before performing the reporting. For instance, after having estimated the SINR at the combiner output for a set of data symbols (e.g. orthogonal frequency division multiplex, OFDM, resource elements), a mapping function is used to obtain the estimated block error rate (BLER) for different alternative transport formats. The channel quality information may then correspond to a transport format not exceeding or being closest to a certain BLER. The mapping function for OFDM may be based on e.g. the so-called mutual information effective SINR mapping.

In another variant, the providing of information comprises: receiving the precoding vector information, the channel quality information, and the channel quality degradation information in a base station of the cell, and correlating the channel quality degradation information with corresponding secondary precoding vectors of the selected ordered set based on an order of reception of the channel quality degradation information. In this way, the number of bits required for the feedback may be reduced considerably.

In one improvement of this variant, the method further comprises: serving the first user equipment using the primary precoding vector, and serving the second user equipment on the same time and frequency resources using one of the plurality of secondary precoding vectors. The selection of the secondary precoding vector used for the multi-user transmissions will be based on the corresponding value of the channel quality degradation information, and possibly on further scheduling constraints.

In a further variant, the method further comprises: signaling information about the ordered set of secondary precoding vectors associated with a respective primary precoding vector from the base station to the user equipments of the cell. The secondary precoding vectors (fixed companions) may either be stored in a static way both at the base station and the user equipment(s) or they may be dynamically attributed, i.e. the fixed companions may be signaled on the forward link from the base station to the user equipment(s). The selection of the fixed companions may be optimized based on codebook properties, antenna configuration and propagation environment. Typically, the fixed companions are the weights resulting in the potentially most attractive pairing combination(s).

Further features and advantages are stated in the following description of exemplary embodiments, with reference to the figures of the drawing, which shows significant details, and are defined by the claims. The individual features can be implemented individually by themselves, or several of them can be implemented in any desired combination.

### BRIEF DESCRIPTION OF THE FIGURES

Exemplary embodiments are shown in the diagrammatic drawing and are explained in the description below. The following are shown:

FIGURE the only FIGURE shows a schematic representation of an embodiment of a SDMA-capable cell according to the invention.

### DESCRIPTION OF THE EMBODIMENTS

The functions of the various elements shown in the Figures, including any functional blocks labeled as ‘processors’, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term ‘processor’ or ‘controller’ should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

FIGURE shows a cell C of a radio communications system 1 which, in the present example, is in compliance with the LTE advanced standard and comprises a base station BS and two user equipments UE1, UE2 which are served by the base station BS. The base station BS (eNodeB) comprises an array of four antennas A1 to A4 in a closely spaced configuration, allowing the cell C to perform space-division multiple access to the user equipments UE1, UE2 arranged in the cell C, i.e. serving the user equipments UE1, UE2 using downlink precoding with different precoding vectors w. In the present case, each precoding vector w has four entries, each entry representing a (usually complex-valued) transmission weight factor for one of the four antennas A1 to A4.

In the cell C, a pre-defined number of eight precoding vectors w, each containing different antenna weights, has been defined and stored in a table (codebook) both at the base station BS and in the user equipments UE1, UE2. A so-called codebook index is assigned to each precoding vector w in the table, indexes a corresponding precoding vector w of the codebook, the precoding vectors of the codebook being e.g. ordered according to the angles of the resulting antenna pattern of the antennas A1 to A4.

For selecting an appropriate transmit format (modulation and coding scheme) for the downlink transmissions to e.g. the first user equipment UE1, the first user equipment UE1 estimates a single-user MIMO channel matrix H (e.g. from cell-specific reference symbols which are orthogonal per antenna A1 to A4). An optimum precoding vector w_{PMI} (primary precoding vector) for downlink transmissions to the first user equipment UE1 is then chosen from the eight precoding vectors w of the codebook based on the channel estimate. The primary precoding vector w_{PMI} typically optimizes a certain optimality metric such as a transmission throughput according to a specific scheduling criterion, or a maximum receive power at the first user equipment UE1. Once the primary precoding vector w_{PMI} has been determined, a three-bit precoding vector index, PMI, indexing the primary precoding vector w_{PMI} in the codebook is fed back from the first user equipment UE1 to the base station BS, together with a channel quality indicator CQI indicating a channel quality when using the primary precoding vector w_{PMI} for scheduling the first user equipment UE1 on a specific time and frequency resource (block). The channel quality indicator CQI may then be used at the base station BS for selecting an appropriate transport format (modulation and coding scheme) for downlink transmissions to the first user equipment UE1 on the specific resource.

In the way described above, single-user MIMO with downlink precoding to the first user equipment UE1 can be provided. However, this approach has to be modified for multi-user MIMO, i.e. for the case that two or more user equipments UE1, UE2 are to be scheduled simultaneously on the same (time and frequency) resources. For multi-user MIMO, a selection of those combinations of precoding vectors which are best suited for multi-user transmissions has to be performed, i.e. for each primary precoding vector w_{PMI}, a number of secondary precoding vectors w_{FCI} has to be determined for the pairing.

The secondary precoding vectors w_{FCI} to be associated with a respective primary precoding vector w_{PMI} may be chosen based on a general design principle which anticipates the attractive weight combinations for the pairing. The general design principle may be based on the following criteria:
Angular properties of the weight vectors (e.g. angle of departure of computed maximum of antenna pattern);
Orthogonality of the weight vectors;
Quasi-orthogonality of the weight vectors: Checking a distance metric, e.g. a scalar product of the vectors and choosing combinations which result in a scalar product close to zero;
SINR statistics obtained from simulations or measurements, tailored to antenna configuration, codebooks and propagation scenario.

In an example case with four closely-spaced correlated transmit antennas at the base-station in conjunction with a codebook designed to cover the angles of a sector by beamforming it is typical that, the secondary precoding vectors W_{FCI} (indexed by a fixed companion index FCI) are taken from a subset of non-neighbored beams (as the neighbored ones for MU-MIMO would result in high cross-talk, thus being unattractive for pairing). It is also possible to use a statistics about the channel quality degradation when pairing precoding vectors w of the codebook with a respective primary precoding vector w_{PMI}, and selecting the secondary precoding vectors w_{FCI} which result in the lowest average channel quality degradation delta-CQI, as those are the precoding vectors w which are the most attractive pairing choices. The number of fixed companions FCI associated with a respective codebook index PMI may be chosen as a trade-off between channel knowledge and required feedback rate.

Once the secondary precoding vectors w_{FCI} have been found, an (implicitly) ordered set of fixed companion indices FCI is attributed to each codebook index PMI, e.g. in the following way:

| Codebook index (PMI) | ordered fixed companion indices (FCI) |
|---|---|
| 1 | 4, 5, 6, 7 |
| 2 | 5, 6, 7, 8 |
| 3 | 6, 7, 8, 1 |
| 4 | 1, 6, 7, 8 |
| 5 | 1, 2, 7, 8 |
| 6 | 1, 2, 3, 8 |
| 7 | 1, 2, 3, 4 |
| 8 | 2, 3, 4, 5 |

The ordered set of four fixed companion indices FCI associated with each codebook index PMI is known at both ends of a transmission link, i.e. both at the base station BS and at the user equipments UE1, UE2. The precoding vectors which are indexed by the fixed companion indices FCI form an ordered set of secondary precoding vectors w_{FCI}.

The fixed companions may either be stored in a static way both at the base station BS and the user equipments UE1, UE2, or they may be attributed dynamically, i.e. the fixed companions FCI attributed with each codebook index PMI may be signaled on a forward link FL1, FL2 from the base station BS to the first and second user equipments UE1, UE2.

Once the first user equipment UE1 has determined the primary precoding vector w_{PMI} with codebook index PMI, channel quality degradation information delta-CQI1 to delta-CQI4 is calculated for each of the four secondary precoding vectors w_{FCI} in a similar way as the channel quality information CQI is calculated for the primary precoding vector w_{PMI}. An example of an explicit calculation of the channel quality degradation information will be given further below.

For each of the secondary precoding vectors w_{FCI}, a channel quality degradation information value delta-CQI1 to delta-CQI4 is fed back on a reverse link RL to the base station BS, the respective values being represented e.g. in the form of a sequence of thee bits. At the base station BS, the channel quality degradation information is then attributed to a corresponding fixed companion index FCI of the ordered set, such that the corresponding secondary precoding vector w_{FCI} can be identified. The correlation is done based on an order of reception of the channel quality degradation information delta-CQI1 to delta-CQI4, i.e. by attributing the first, second, . . . channel quality degradation information delta-CQI1, delta-CQI2, . . . to the first, second, . . . fixed companion index FCI of the ordered set.

The base station BS may then use its transmission unit TU for serving the first user equipment UE1 using the primary precoding vector w_{PMI}, and may select one of the secondary precoding vectors w_{FCI} for serving the second user equipment UE2 on the same time and frequency resources. The selection of the specific secondary precoding vector w_{FCI} used for the transmissions may be made in dependence on the corresponding quality degradation value and on further scheduling constraints. For instance, the secondary precoding vector W_{FCI} having the smallest channel quality degradation value delta-CQI may be selected.

It will be understood that alternatively, in order to further reduce the required feedback rate, instead of providing channel degradation information for each of the secondary precoding vectors, a single channel degradation information value may be provided as a feedback to the base station, the single value being averaged over all fixed companions FCI. Averaging over at least part of the fixed companions is particularly advantageous when instead of a single codebook (as described above), a composite codebook (comprising two or more codebooks and respective codebook indices) is used. In this case, it is possible to perform signalling of the (individual) delta-CQIs associated to the first codebook, while forming an average over all possible entries of the second codebook (or vice versa). Alternatively, the averaging may be performed over a subset, e.g. best N, where N is an integer which could range from 1 to the number of codebook entries.

In the following, a detailed example for the determination of the channel quality degradation information delta-CQI in a user equipment UE1, UE2 will be given. As indicated above, the user equipment UE1, UE2 estimates the MIMO channel matrix H (e.g. from cell-specific reference symbols which are orthogonal per antenna) and determines the codebook index PMI of the primary precoding vector w_{PMI} to be used for the transmissions to the first user equipment UE1.

The resulting linear SINR for the case of a single stream transmission may then be computed in the following way:

$${γ}_{Rank 1} = \frac{{P}_{Tx} {\vert {w}_{Rx , rank 1}^{T} {Hw}_{PMI} \vert}^{2}}{I + N} ;$$

with P_{TX} denoting the transmit power, W_{RX, rank1}^{T} denoting the receive combiner for the transmit PMI weight (e.g. maximum ratio combiner MRC), H denoting the MIMO channel matrix, W_{PMI} the primary precoding vector, I the inter-cell interference power, and N the noise power. The inter-cell interference power I and the noise power N are measured at the output of the receive combiner. With M, K being the number of receive and transmit antennas, respectively, H is of dimension M×K, w_{PMI} is a K×1 vector and W_{Rx,rank1}^{T} is a 1×M vector.

For each of the known weights of the secondary precoding vectors w_{FCI} (obtained by reading out the corresponding table entries), the SINR at the output of a receive combiner (e.g. a minimum mean squared error combiner—MMSE) is calculated taking into account the resulting portion of intra-cell interference from the fixed companion weight. The resulting intra-cell interference I_{int,ra} when having a pairing partner with a fixed companion index FCI is (in case the transmit power is split equally between the two users):

I_{int ra}=0.5·P_{Tx}|w_{Rx,MU}^{T}Hw_{FCI}|².

As indicated above, the secondary precoding vectors w FCI of the fixed companion indices FCI are known from a stored table. The receive weights W_{Rx,MU}^{T} may be set equal to w_{Rx,rank1}^{T} (e.g. for the case of a MRC receiver) or they may be designed in order to suppress the multi-user interference, e.g. using an MMSE receiver.

The resulting linear SINR with the fixed companion index FCI is then given by:

$${γ}_{pairing} = \frac{0.5 \cdot {P}_{Tx} {\vert {w}_{Rx , MU}^{T} {Hw}_{PMI} \vert}^{2}}{I + N + {I}_{int ra}} .$$

It will be understood that a different power loading may be easily achieved by replacing the factor of 0.5 by a different value.

The channel quality degradation value delta-CQI may now be based on the SINR difference between rank 1 and paired transmission:

Δγ=10 log₁₀(γ_{Rank1})−10 log₁₀(γ_{pairing})

Now, either this difference may be reported directly as feedback information, or, e.g. in the case of LTE, it may be mapped to a change in desired transport format index, using adaptive modulation and coding.

In case of two multi-user streams and equal power splitting, it is evident that the SINR difference Δγ will be at least 3 dB. Therefore, one may subtract this value from the reporting value provided over the reverse link RL (and take it into account at the base station BS) to increase the dynamic range with the limited number of e.g. three bits which is used for quantization of the channel quality degradation information delta-CQI. For instance, when the transport formats are tailored to a 1 dB step size in SINR, for link adaptation, one implicitly subtracts three transport formats. The resulting channel quality degradation value delta-CQI now indicates the additional number of transport formats which have to be subtracted to consider the intra-cell interference correctly, e.g. 0-7 with 8 bits and uniform quantization. It is of course also possible to use non-uniform quantization. In the present case, the channel quality degradation values delta-CQI are negative, as they indicate a loss due to pairing, caused by intra-cell interference and splitting of transmit power.

In summary, the CQI information feedback provided in ordinary LTE systems only gives information for single-user MIMO. In the way described above, information for multi-user MIMO is provided which may be used to support: Knowledge of MU-MIMO intra-cell interference, user selection and scheduling (e.g. weighted sum rate scheduling), and link adaptation (appropriate choice of modulation and coding). All those aspects come along with a very low feedback rate, such that multi-user MIMO throughput and thus spectral efficiency may be increased using the above proposal.

Moreover, one skilled in the art will appreciate that although in the above description, the feedback has been designed for pairing two user equipments, i.e. two streams of MU-MIMO transmission, the approach described above may also be used to transmit to more than two users at the same time. In this case, for scheduling and link adaptation, delta-CQI information for more than two MU-MIMO streams may be estimated in an appropriate way, e.g. based on the existing available delta-CQI information for pairing.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Also, the description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. Base station for a SDMA-capable cell of a radio communications system, adapted for:
receiving precoding vector information indicating a primary precoding vector in an ordered set of precoding vectors, receiving channel quality information indicating a channel quality when using the primary precoding vector for scheduling a first user equipment,
receiving channel quality degradation information indicating a degradation of a channel quality when scheduling a second user equipment on the same time and frequency resources using a secondary precoding vector,
wherein
the secondary precoding vector is one of a pre-defined ordered set of secondary precoding vectors which is associated with the primary precoding vector for which the precoding vector information is received, the base station being further adapted for:
correlating the channel quality degradation information with corresponding secondary precoding vectors of the associated ordered set based on an order of reception of the channel quality degradation information.

2. Base station according to claim 1, further comprising: a transmission unit adapted for serving the first user equipment using the primary precoding vector, the transmission unit being further adapted for serving the second user equipment on the same time and frequency resources using one of the plurality of secondary precoding vectors.

3. Base station according to claim 1, further adapted for signaling information about the ordered sets of secondary precoding vectors associated with respective primary precoding vectors to the user equipments of the cell.

4. User equipment for a SDMA capable cell of a radio communications system, adapted for:
generating precoding vector information for indicating a primary precoding vector in an ordered set of precoding vectors, generating channel quality information indicating a channel quality when using the primary precoding vector for scheduling a first user equipment,
wherein
generating an ordered set of channel quality degradation information indicating a degradation of a channel quality when scheduling a second user equipment on the same time and frequency resources using a secondary precoding vector from a pre-defined ordered set of secondary precoding vectors being associated with the primary precoding vector for which the precoding vector information is generated.

5. User equipment according to claim 4, further adapted for: determining the channel quality degradation information from a channel quality after receive combining, taking intra-cell interference due to transmissions using the secondary precoding vector into account.

6. User equipment according to claim 4, wherein an influence of a predefined power splitting to the user equipments on the channel quality degradation is removed from the channel quality degradation information.

7. SDMA-capable cell for a radio communications system, comprising:
at least one of a base station according to claim 1 and a user equipment adapted for generating precoding vector information for indicating a primary precoding vector in an ordered set of precoding vectors, generating channel quality information indicating a channel quality when using the primary precoding vector for scheduling a first user equipment, wherein
generating an ordered set of channel quality degradation information indicating a degradation of a channel quality when scheduling a second user equipment on the same time and frequency sources using a secondary precoding vector from a pre-defined ordered set of secondary precoding vectors being associated with the primary precoding vector for which the precoding vector information is generated.

8. Radio communications system comprising at least one SDMA capable cell according to claim 7.

9. Method for providing information for scheduling at least two user equipments on the same resources of a SDMA-capable cell of a radio communications system, the method comprising: providing precoding vector information indicating a primary precoding vector in an ordered set of precoding vectors, providing channel quality information indicating a channel quality when using the primary precoding vector for scheduling a first user equipment,
wherein
providing an ordered set of channel quality degradation information indicating a degradation of a channel quality when scheduling a second user equipment on the same time and frequency resources using a secondary precoding vector of a predefined ordered set of secondary precoding vectors being associated with the primary precoding vector for which the precoding vector information is generated.

10. Method according to claim 9, wherein an attribution of precoding vectors to the pre-defined ordered set of secondary precoding vectors is performed based on at least one of a relation of the precoding vectors to the primary precoding vector, in particular a distance metric to the primary precoding vector, and a channel quality statistics within the cell.

11. Method according to claim 9, wherein a pre-defined power splitting to the user equipments is performed, and wherein a contribution of the pre-defined power splitting on the channel quality degradation is removed from the channel quality degradation information.

12. Method according to claim 9, further comprising:
determining the channel quality degradation information from a channel quality after receive combining, taking intra-cell interference due to transmissions using the secondary precoding vector into account.

13. The method according to claim 9, wherein the providing of information comprises:
receiving the precoding vector information, the channel quality information, and the channel quality degradation information in a base station of the cell, and correlating the channel quality degradation information with corresponding secondary precoding vectors of the selected ordered set based on an order of reception of the channel quality degradation information.

14. The method according to claim 13, further comprising: serving the first user equipment using the primary precoding vector, and serving the second user equipment on the same time and frequency resources using one of the plurality of secondary precoding vectors.

15. The method according to claim 13, further comprising: signaling information about the ordered set of secondary precoding vectors associated with a respective primary precoding vector from the base station to the user equipments of the cell.
